(19) United States
(12) Patent Application Publication
(10) Pub. No.: US 2005/0012347 A1
(43) Pub. Date: Jan. 20, 2005

(54) Apparatus for and method of removing a pulley

(76) Inventors: Gale L. Smith, Dallas County, TX (US); Timothy A. Crawford, Dallas County, TX (US)

Correspondence Address: Mr. Harry C. Post, III;ROBINSON & POST, L.L.P., Suite 575, 12900 Preston Road, LB-29, Dallas, TX, 75230-1329, US

(21) Appl. No.: 10/622,401

(22) Filed: Jul. 18, 2003

(51) Int. Cl. B25J 1/04

(52) U.S. Cl. 294/19.1

(57) ABSTRACT

A hand held tool to prevent a pulley from rotating around an axis of rotation. A handle portion is provided on the tool to be held by a user of the tool. An engaging portion is provided to grip a portion of the pulley and prevent the pulley from rotating around the axis when said handle portion is held by the user. A tool is used to remove a fan clutch on an automobile engine. The tool has a handle portion having a user gripping portion disposed at one end and a connecting portion at another end. An engaging portion is used to grip a rim of the pulley and prevent the pulley from rotating around its rotating axis. The engaging portion has a U-shaped body with a base connected to the connecting portion of the handle portion and two arms extending radially from an axis formed by the elongated rod of the handle portion. The arms are displaced from one another by an amount sufficient to receive a rim of the pulley and have a sufficient size to form a friction surface to inhibit rotation of the pulley around its rotating axis when the arms engage the rim of the pulley.

### BACKGROUND OF THE INVENTION

This invention relates to a hand held tool to prevent a pulley from rotating around an axis of rotation, a tool used in removing a fan clutch on an automobile engine, and a method of removing a fan clutch on an automobile engine,

### BRIEF SUMMARY OF THE INVENTION

When the water pump on an engine of a motor vehicle; such as a car or truck, fails, it is necessary that the pulley providing the rotating power to the water pump be removed. This pulley is driven by a belt driven by a pulley connected to the vehicle engine. Frequently, this pulley also rotates a fan, which moves air through the motor vehicle's radiator. Thus, there is very little room or space between the engine and the radiator in which a mechanic has available to work in removing this pulley.

Some tools have been made to prevent pulley from rotating by engaging bolts holding the pulley to the water pump, but these tools leave the mechanic less room to work and will only work on pulleys that have such bolts.

A pipe wrench has been used by some mechanics to engage the fan clutch nut and prevent the pulley from rotating. However, the handle on a conventional pipe wrench is not sufficiently long to find clearance among the several parts on the front of the engine.

Accordingly, it is an object of the present invention to provide a hand held tool to prevent a pulley from rotating around an axis of rotation. A handle portion is provided on the tool to be held by a user of the tool. An engaging portion of the tool is adapted to grip a portion of the pulley and prevent the pulley from rotating around the axis when said handle portion is held by the user.

Further, it is an object of the present invention to provide a tool used in removing a fan clutch on an automobile engine. The tool has a handle portion for being held by a user of the tool and an engaging portion adapted to grip a rim of the pulley. The handle portion has an elongated rod with a user gripping portion disposed at one end and a connecting portion at another end. The engaging portion prevents the pulley from rotating around its rotating axis has a U-shaped body with a base connected to the connecting portion of said handle portion and two arms extending radially from an axis formed by the elongated rod of said handle portion. The arms are displaced from one another by an amount sufficient to receive the rim of the pulley and have a sufficient size to form a friction surface to inhibit rotation of the pulley around its rotating axis when the arms engage the rim of the pulley.

Further, it is an object of the present invention to provide a method of removing a fan clutch on an automobile engine. The method comprises the steps of engaging a rim of a pulley used to drive a fan clutch and water pump in the automobile engine with one end of a tool that provides friction resistance to rotating movement of the pulley. A nut holding a fan clutch, water pump and pulley together is removed by using a wrench while preventing movement of the pulley by grasping an end of the tool to prevent movement of the pulley. The fan clutch is separated from the automobile engine after the nut is removed.

### BRIEF DESCRIPTION OF THE SEVERAL VIEWS OF THE DRAWING

Objects and advantages of the invention will become apparent upon reading the following detailed description and upon reference to the drawings, wherein like reference characters are used throughout to designate like parts:

FIG. 1 is a perspective view of a tool constructed according to the present invention;

FIG. 2 is a plan view of a portion of and taken along one side of the tool shown in FIG. 1;

FIG. 3 is an end view of the tool shown in FIG. 2;

FIG. 4 is an enlarged plan view of another portion of the tool shown in FIG. 1;

FIG. 5 is an end view of the other portion of the tool shown in FIG. 4;

FIG. 6 is a side plan view of the other portion of the tool shown in FIG. 5; and

FIG. 7 is a view of the tool shown in FIG. 1 engaging a pulley at the front of a motor vehicle's engine.

### DETAILED DESCRIPTION OF THE INVENTION

Turning now to FIGS. 1 and 7, there is shown a hand held tool 10 used to prevent a pulley 12 from rotating its axis of rotation 14. Pulley 12 is used in a motor vehicle to drive a water pump 16 and a fan via a fan clutch 18 that is secured to pulley 12 by a nut 20 in a conventional manner.

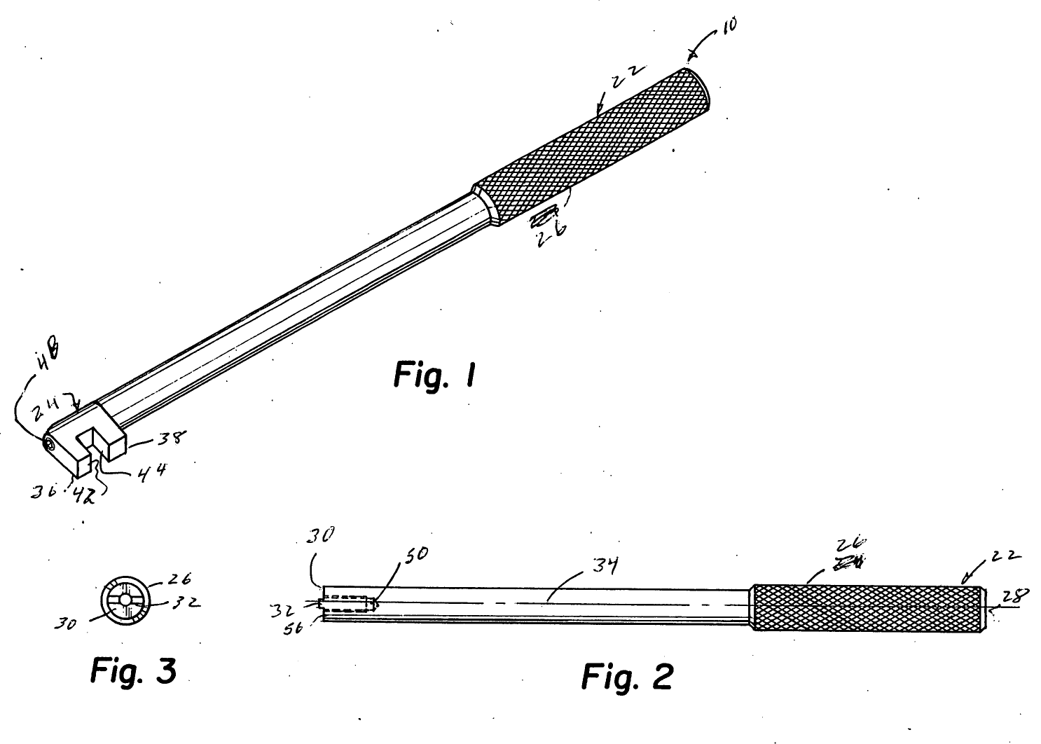

As best seen in FIGS. 1-3 and 7, tool 10 has a handle portion 22 to be held by a user of tool 10 and an engaging portion 24 adapted to grip a portion of pulley 12 and prevent pulley 12 from rotating around axis 14 when handle portion 22 is being held by the user of tool 10.

Handle portion 22 has a size and shape sufficient to extend through lines and hoses provided on a motor vehicle or automobile engine when pulley 12 is connected to water pump 16 that is being used on the engine. A diamond knurl 26 is provided on one end or holding end 28 of handle portion 22 to assist a user in gripping tool 10. At the other end or connecting end 30 of handle portion 22 is a shoulder 32 for preventing movement of engaging portion 24 relative to handle portion 22.

To make tool 10 lighter and easier to use, handle portion 22 may be constructed from aluminum in an elongated bar configuration with an axis of symmetry 34 extending along its elongate axis. Shoulder 32 may then be disposed to extend radially from axis of symmetry 34 on connecting end 30.

It has been found that tool 10 will provide the desired result when handle portion 22 is about 14 inches in length and has a diameter of about 1 inch at holding end 28 and of about 0.75 inch at connecting end 30. The diamond knurl 26 extends for about 5 inches from holding end 28 and terminates were handle portion 22 has a diameter of about 0.75 inch, which is about 9 inches from connecting end 30.

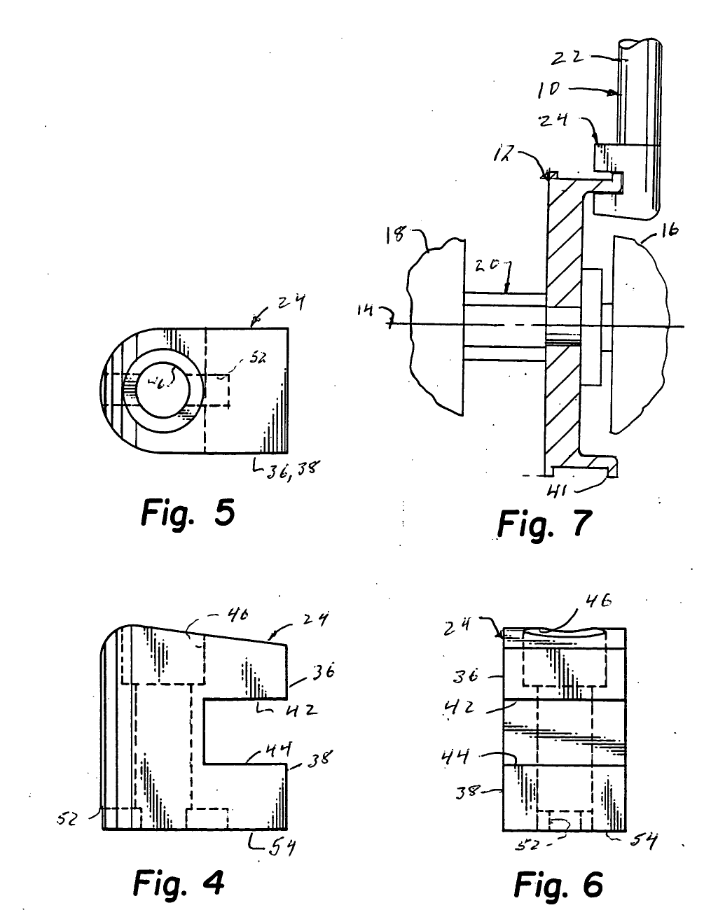

As best seen in FIGS. 1 and 4-6, engaging portion 24 of tool 10 has first and second engaging members 36 and 38, respectively, extending from a body 40 to form a generally “U” shape. First and second engaging members 36 and 38 are displaced from one another by a distance sufficient to receive a portion; such as rim 41 formed for the drive belt as shown in FIG. 7, of pulley 12. First engaging member 36 has a first engaging surface 42 and second engaging member 38 has a second engaging surface 44. First engaging surface 42 and second engaging surface 44 are disposed on their respective engaging members 36 and 38, respectively, so as to face one another.

It has been discovered that when the distance between the first and second surfaces is about 0.41 inches, the rims of a significant number of pulleys will pass between facing surfaces 42 and 44 without damaging the pulley.

It has also been discovered that when engaging portion 24 is made from steel and engaging surfaces 42 and 44 have a depth of about 0.5 and a width of about 0.75 inch that a friction force sufficient to prevent pulley 12 from rotating around axis 14 can be generated by tool 10.

A passageway 46 extends through body 40 of engaging portion 24 for receiving a bolt 48 that threadedly engages in an aperture 50, which is provided in the connecting end 30 of handle portion 22 to extend coincidentally along axis of symmetry 34.

A groove 52 is made in body 40 extending inwardly from a surface 54 that butts against a corresponding surface 56 on connecting end 30 of handle portion 22. Thus, when handle portion 22 and engaging portion 24 are connected with shoulder 32 disposed within groove 52, engaging portion 24 is prevented from rotating relative to handle portion 22.

To remove fan clutch 18 on a motor vehicle engine, rim 41 of pulley 12 used to drive fan clutch 18 and water pump 16 in the motor vehicle engine is engaged by engaging portion 24 of tool 10 and thereby provide friction resistance to rotating movement of pulley 12. Nut 20 that holds fan clutch 18, water pump 16 and pulley 12 together is removed with a conventional wrench while pulley 12 is prevented from rotating by grasping diamond knurl 26 on holding end 28 of tool 10 to prevent movement of pulley 12. Fan clutch 18 is then separated from the motor vehicle engine after nut 20 is removed. When desired, the drive belt is removed from pulley 12 before engaging the pulley with tool 10. Also, when desired, tool 10 is chosen to have a length sufficiently long to extend outwardly of pulley 12 by a sufficient distance to inhibit interference with the wrench being used to remove nut 20.

1. A hand held tool to prevent a pulley from rotating around an axis of rotation, comprising: a handle portion adapted to be held by a user of the tool and an engaging portion adapted to grip a portion of the pulley and prevent the pulley from rotating around the axis when said handle portion is held by the user.

2. The tool set forth in claim 1, further comprising: said gripping portion having first and second engaging members, the first and second engaging members being displaced from one another by a distance sufficient to receive the portion of the pulley.

3. The tool set forth in claim 2, further comprising: the first and second engaging members of said gripping portion being disposed sufficiently away from one another to receive a rim of the pulley.

4. The tool set forth in claim 3, further comprising: the first engaging member of said gripping portion having a first engaging surface, the second engaging member of said gripping portion having a second engaging surface, the first and second engaging surfaces being disposed on the engaging members to face one another.

5. The tool set forth in claim 4, further comprising: the first and second engaging surfaces being of a size sufficient to inhibit movement of the rim of the pulley relative to the first and second engaging members.

6. The tool set forth in claim 1, further comprising: said handle portion being disposed at one end of the tool and said engaging portion being at another end of the tool.

7. The tool set forth in claim 6, further comprising: said handle portion having a size and shape sufficient to extend through lines and hoses provided on an automobile engine when the pulley is a water pump pulley being used on an automobile engine.

8. The tool set forth in claim 7, further comprising: said handle portion having a diamond knurl to assist a user in gripping the tool.

9. A tool used in removing a fan clutch on an automobile engine, comprising: a handle portion for being held by a user of the tool having an elongated rod with a user gripping portion disposed at one end and a connecting portion at another end; and an engaging portion adapted to grip a rim of the pulley and prevent the pulley from rotating around its rotating axis having a U-shaped body with a base connected to the connecting portion of said handle portion and two arms extending radially from an axis formed by the elongated rod of said handle portion, the arms being displaced from one another by an amount sufficient to receive the rim of the pulley and having a sufficient size to form a friction surface to inhibit rotation of the pulley around its rotating axis when the arms engage the rim of the pulley.

10. The tool set forth in claim 9, further comprising: said elongated rod having a diameter sufficiently small and a length sufficiently long to extend through lines and hoses provided on the automobile engine when the pulley is a water pump pulley being used on the engine.

11. The tool set forth in claim 10, further comprising: said handle portion having a diamond knurl to assist a user in gripping the tool.

12. A method of removing a fan clutch on a motor vehicle engine, comprising the steps of: engaging a rim of a pulley used to drive a fan clutch and water pump in the motor vehicle engine with one end of a tool that provides friction resistance to rotating movement of the pulley; removing a nut holding a fan clutch, water pump and pulley together with a wrench while preventing movement of the pulley by grasping an end of the tool to prevent movement of the pulley; and separating the fan clutch from the motor vehicle engine after the nut is removed.

13. The method set forth in claim 12, further comprising the step of: removing the drive belt from the pulley before engaging the rim of the pulley.

14. The method set forth in claim 12, further comprising the step of: choosing the tool with a length sufficiently long to extend outwardly of the pulley by a sufficient distance to inhibit interference with the wrench.
